(19) United States
(12) Patent Application Publication
(10) Pub. No.: US 2010/0162588 A1
(43) Pub. Date: Jul. 1, 2010

(54) DEVICE FOR DRYING CLOTHES

(76) Inventor: Peter Newman, West Midlands (GB)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/524,124

(22) PCT Filed: Jul. 22, 2008
(86) PCT No.: PCT/GB08/00201

§ 371 Date: Feb. 3, 2010

(30) Foreign Application Priority Data
Jan. 22, 2007 (GB) 0701144.8

(51) Int. Cl. F26B 25/06; F26B 25/18

(52) U.S. Cl. 34/235; 34/239

(57) ABSTRACT

A device for drying clothes includes a tunnel portion (1), a funnel portion (3) provided at least at one end of the tunnel portion, and a hanging system (15, 25) for clothes provided within the tunnel portion.

This invention relates to a device for drying clothes.

The term “clothes” as used herein includes clothing and also other fabric items that may required to be dried, such as linen and towelling.

Traditionally clothes have been hung outdoors on a washing line, or clothes line, using pegs and allowed to dry over a period while being exposed to ambient air. The disadvantage of such a method of drying clothes is that it is dependent on the prevailing weather conditions.

It is, of course, possible to dry clothes indoors, for example on a drying rack. Indoor drying racks are not dependent on the weather, but tend to have limited capacity.

The alternative of mechanical drying equipment, such as a spin dryer or a tumble dryer, is expensive to purchase and to operate.

It is therefore an object of the present invention to provide a device for drying clothes which overcomes, or at least ameliorates, the above-mentioned disadvantages.

According to the present invention there is provided a device for drying clothes including a tunnel portion, a funnel portion provided at least at one end of the tunnel portion, and a hanging system for clothes provided within the tunnel portion.

The device may include a funnel portion provided at each end of the tunnel portion.

The or each funnel portion may be removably attached to a tunnel portion.

A skirt may be provided at least at one end of the tunnel portion, the skirt extending around at least a part of the internal periphery of the tunnel portion and extending radially inwardly therefrom. The material of the skirt may be gathered in the radially inner region thereof and ties may be provided to restrict movement of the skirt longitudinally outwardly of the tunnel portion.

The device may include a plurality of tunnel portions removably connected to each other.

Sides of the tunnel portion may extend downwardly substantially to ground level.

The tunnel portion may include a plurality of hoop-like supporting structures. Alternatively or additionally, the tunnel portion may include a plurality of inflatable supporting structures. The inflatable supporting structures may be provided with valves to permit the structures to be inflated and deflated.

The funnel portion may taper as it approaches the tunnel portion.

At least one end of the tunnel portion may be provided with a retractable canopy. The retractable canopy may comprise one or more doors. The canopy may be provided with at least one aperture.

One or more vents may be provided along the length of the tunnel portion. The vents may be selected from apertures and air-permeable material. Alternatively, the or each vent may be in the form of a chimney.

Flooring means may cover at least a part of the floor of the device. The flooring means may be removably secured to the remainder of the device.

The hanging system may comprise a clothing support which extends between opposite walls of the tunnel portion. The clothing support may be hingedly connected to the opposite walls of the tunnel portion. Alternatively, the clothing support may comprise a plurality of supports which are hinged together and are spaced from the surface of the tunnel portion. The supports may be spaced from the surface of the tunnel portion by means of a plurality of spacers. Alternatively, the supports may be spaced from the surface of the tunnel portion by fabric material.

The device may be secured relative to the ground by means of a weight attached to the remainder of the device. The weight may be secured to the remainder of the device by means of elongate supports which extend longitudinally within at least the tunnel portion. A lower surface of the weight may be rounded and may be received in a complementary recess provided in a support member inserted in the ground.

Thus the present invention provides a device for drying clothes which is environmentally friendly and uses only the directed and controlled movement of ambient air. Clothes can be dried even in bad weather, at any time of the day or night and at any time of the year, and the dried clothes can be essentially free from creases so as to need little or no ironing. The device can be positioned in any convenient space, including in a garden, such as on a patio or a lawn, or on a balcony.

For a better understanding of the present invention and to show more clearly how it may be carried into effect reference will now be made, by way of example, to the accompanying drawings in which:

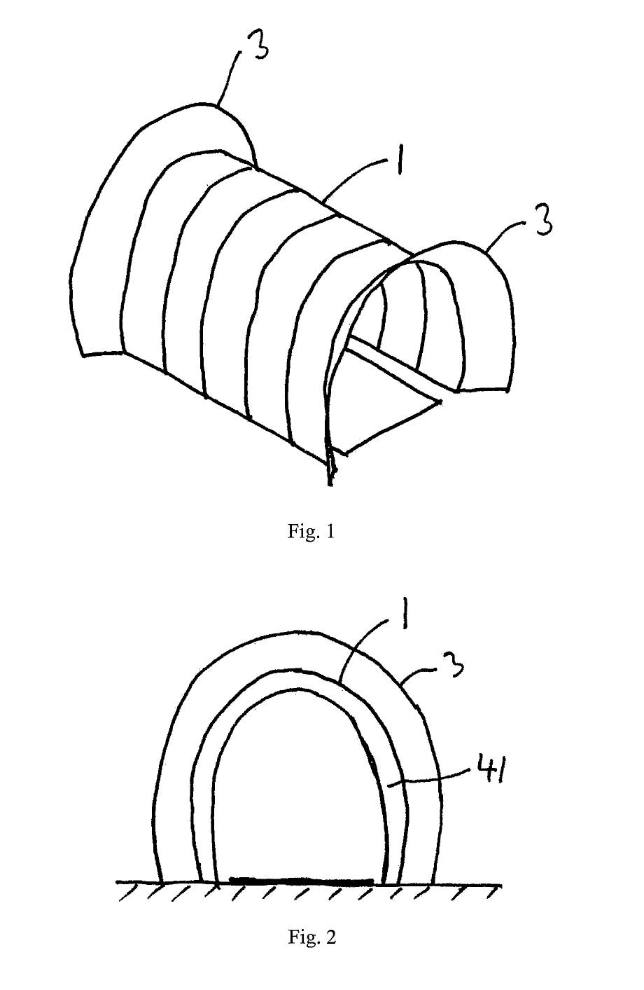

FIG. 1 is a perspective view of one embodiment of a device for drying clothes according to the present invention;

FIG. 2 is an end view of the device shown in FIG. 1;

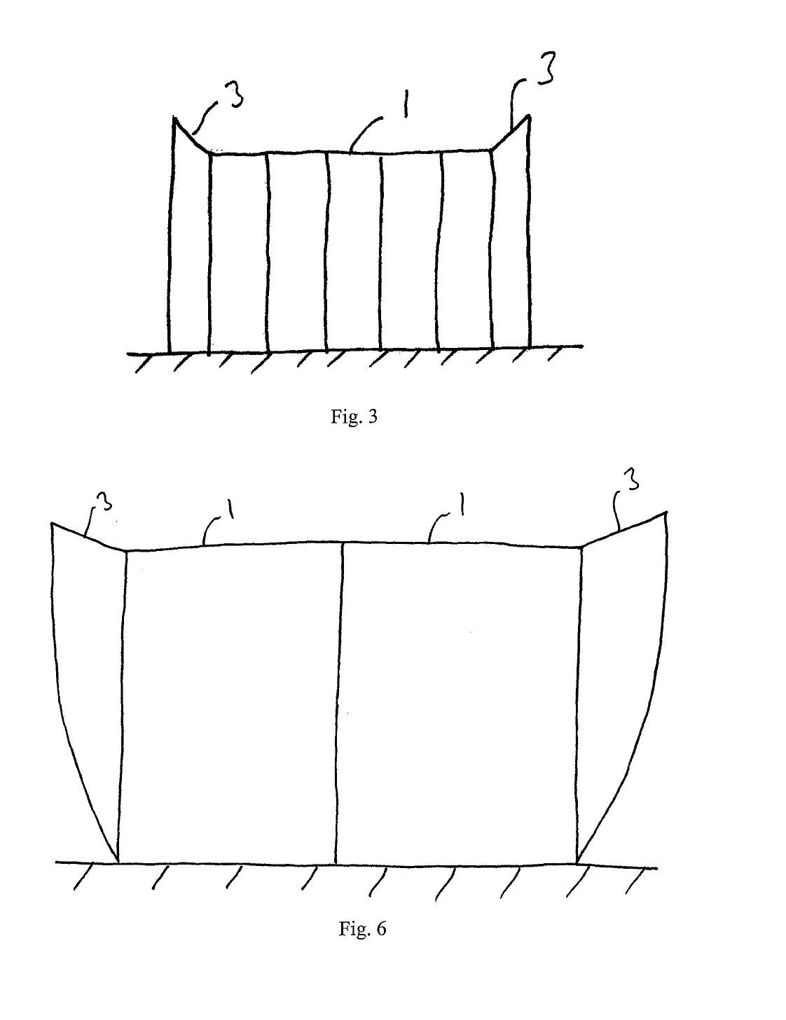

FIG. 3 is a side view of the device shown in FIG. 1;

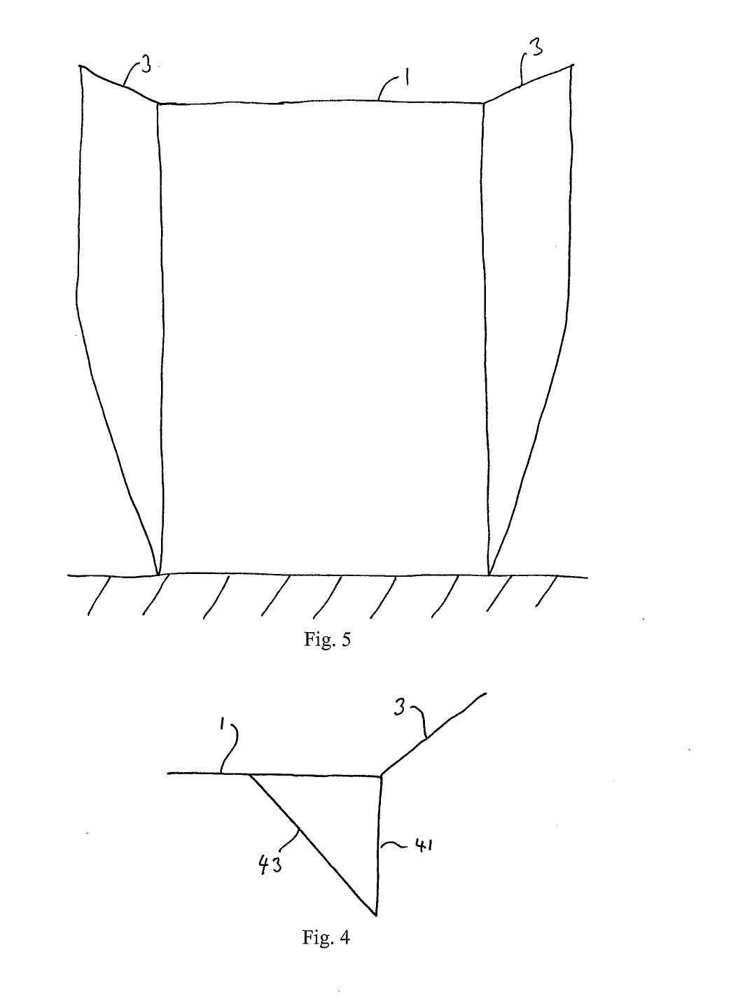

FIG. 4 is a side view of part of the device shown in FIG. 1;

FIG. 5 is a side view of a modified version of the device shown in FIG. 1;

FIG. 6 is a side view of a further modified version of the device shown in FIG. 1;

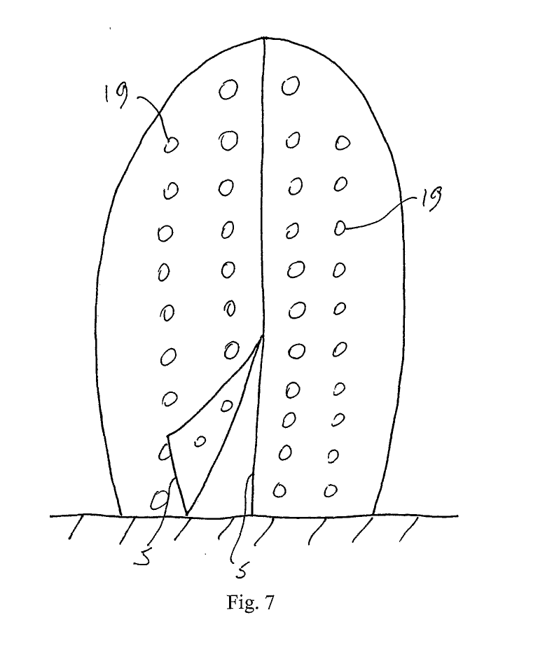

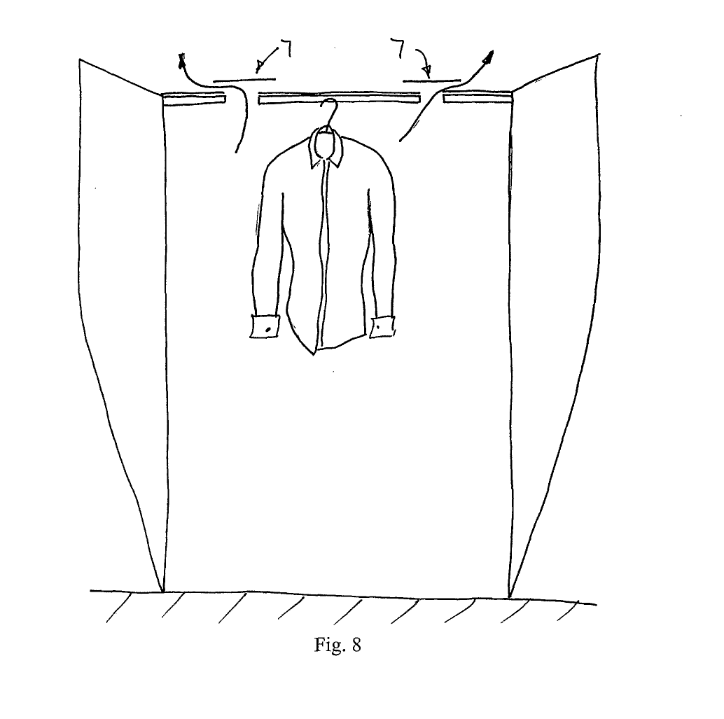

FIG. 7 is an end view of one embodiment of a tunnel portion forming part of a device for drying clothes according to the present invention;

FIG. 8 is a side view of a further modified version of the device shown in FIG. 1;

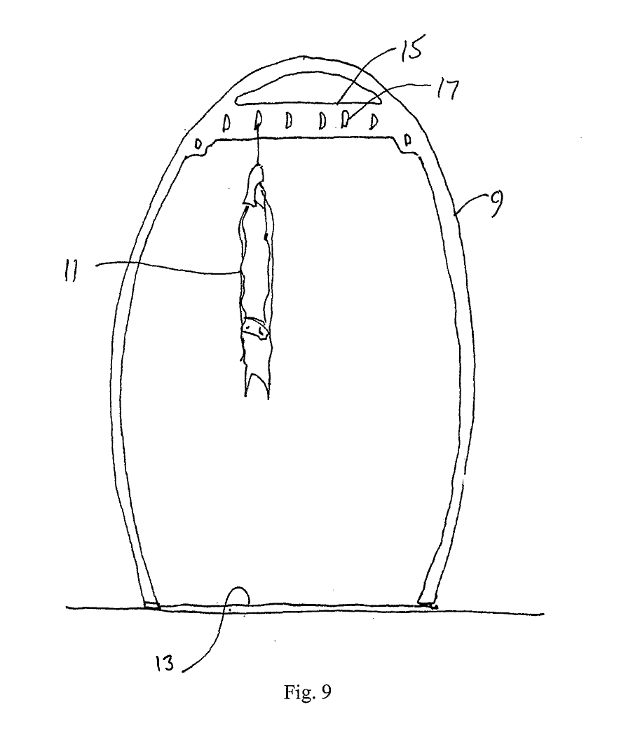

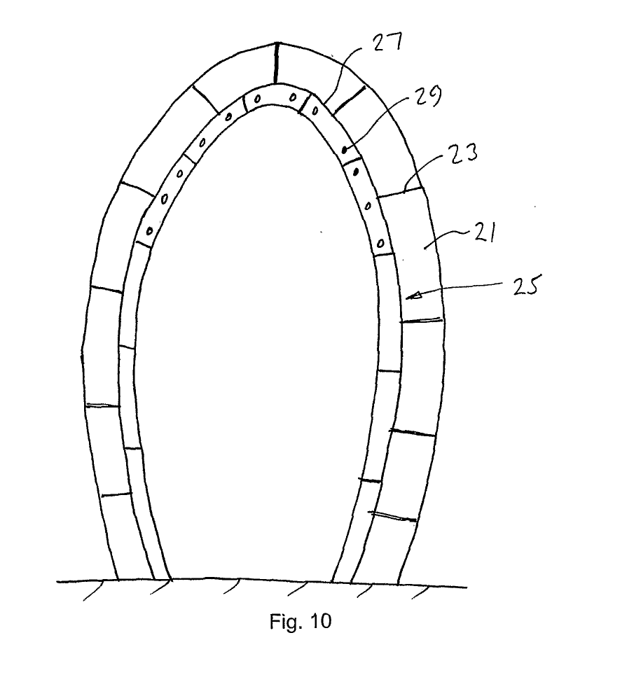

FIG. 9 is an end view of an embodiment of a tunnel portion forming part of a device for drying clothes according to the present invention;

FIG. 10 is an end view of an upper part of an embodiment of a tunnel portion forming part of a device for drying clothes according to the present invention; and

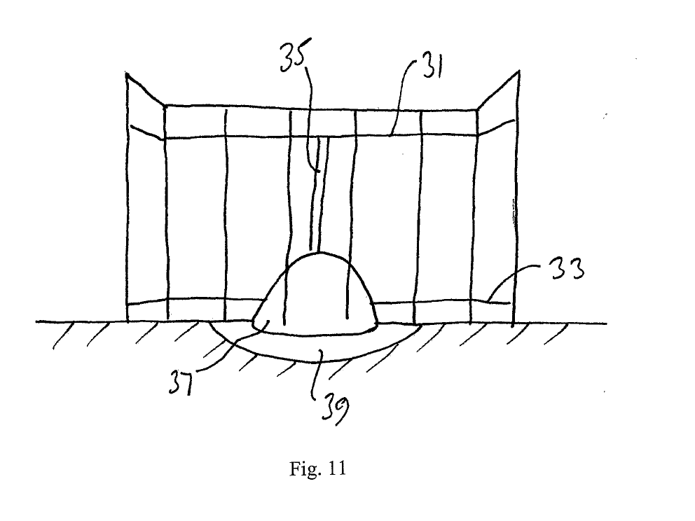

FIG. 11 is a side view of an embodiment of a device for drying clothes according to the present invention, provided with a self-supporting mounting system.

The device for drying clothes shown in FIGS. 1 to 4 comprises a tunnel portion 1 with a funnel portion 3 at each end of the tunnel portion. The tunnel portion has a curved profile as can be seen particularly from FIG. 2 which as shown is part-oval with a region above ground level that is wider than the tunnel at ground level. However, other profiles can be used, such as part circular, square, triangular or the like. A curved or triangular profile has the advantage that water will readily run off the tunnel portion. As a further alternative, although the tunnel as illustrated extends to ground level, it need not do so and the lower edge of the tunnel along one or both sides may be spaced above ground level, the tunnel being supported on legs or the like. If desired, the height of the lower edge of the tunnel may be adjustable. The tunnel portion 1 and the funnel portion 3 may be made of any suitable material such as those commonly used in the manufactured of tents and/or sails. Ideally the material will be waterproof. Optionally, the material may be, or may be coated with, a means for generating solar energy which may be used, for example, for powering a dehumidifier or the like positioned within the tunnel portion 1. The material of the tunnel portion 1 and of the funnel portion 3 may be supported on hoop-like structures such as are conventionally used in tents, for example made of one or more of carbon or glass-fibre reinforced rod or tube materials, metal tubes or rods, and strips of wooden materials.

The funnel portion 3 is secured to the tunnel portion at one end and is free at its other end. The free end of the funnel portion 3 has a greater cross-sectional area than the tunnel portion 1 and tapers as it approaches the tunnel portion such that the cross-sectional area and shape of the funnel portion is the same as the tunnel portion where the two portions join. The shape of the free end of the funnel portion is ideally substantially the same as that of the tunnel portion, but this is not essential. For example, the funnel portion may be tapered in its lower region as shown in FIG. 5 to reduce its longitudinal extent in the lower region. If desired, the funnel portion 3 may be adjustable (larger and/or smaller), for example in cross-sectional area and/or in longitudinal extent, so as to adjust the amount of air that is channelled into the tunnel portion 1.

As can be seen from FIGS. 2 and 4, each end of the tunnel portion 1 is provided around at least a part of the internal periphery of the tunnel portion with a radially inwardly extending skirt 41 of substantially air-impermeable material. The material of the skirt 41 is gathered, or creased (for example pleated) in the radially inner region thereof such that the inner region of the skirt is able to expand. Movement of the radially inner region of the skirt 41 is controlled by a plurality of substantially inextensible ties, including tie 43, which extend substantially between the radially inner edge of the skirt and the inner face of the tunnel portion 1. In this way, the ties 43 prevent the skirt extending longitudinally outwardly from the tunnel portion 1, while the gathering allows the skirt to move longitudinally inwardly of the tunnel portion, the radially inner region of the skirt moving radially outwardly towards the inner face of the tunnel portion. In this way, the skirt 41 allows the passage of air into the tunnel portion 1, but restricts the passage of air out of the tunnel portion.

The device may be secured to any convenient object. For example support cords (not shown) may extend to pre-existing fixings for a washing line or a rotary dryer or may be secured to decking, pegs or any other suitable fixing point.

In use of the device shown in FIGS. 1 to 4, ambient air passes through the device, entering through one funnel portion, passing through the tunnel portion and exiting through the other funnel portion. The tapering funnel portion creates a Venturi effect, increasing the speed of air flow through the tunnel portion and consequently increasing the drying effect on clothes supported within the tunnel. The tunnel portion 1 additionally protects clothes from UV radiation from the sun and from bird droppings and the like.

FIG. 6 shows that the device may be made in modular fashion. That is, the tunnel portion 1 may be manufactured separately from the funnel portions 3 and the portions may be secured together and separated by, for example, a sliding fastener such as a zip fastener, press studs, hook and loop material such as that sold under the trade mark Velcro, and the like. In this way the number of tunnel portions 1 can be varied, with two or more tunnel portions being an option for drying a greater number of clothes. It should be noted that the tunnel portion 1 need not be straight along its length and could be curved or angular.

As shown in FIG. 7, one or both ends of the tunnel portion 1 may be provided with a retractable canopy, such as doors 5. The doors may be rolled or folded back in good weather, but may be unfolded and closed to protect clothing within the tunnel during bad weather. The doors 5 may also assist in regulating the flow of air into and/or out of the device. If desired, only a single door may be closed, leaving the end of the tunnel portion 1 partly open. The canopy or doors 5 may be provided with one or more apertures 19 which may influence the passage of air through the device. The apertures may be open or may be covered with an air-permeable material such as perforated, net, mesh or breathable fabric.

FIG. 8 shows that regions 7 of the surface of the tunnel portion 1 may permit the passage of air through the wall of the tunnel portion, for example to reduce the pressure of air within the tunnel portion and to increase the movement of air within the tunnel portion. Ideally, the regions may be in the form of vents and may be provided in an upper region of the tunnel portion 1. The vents may be positioned at any convenient place in the wall of the tunnel portion and may be apertures in the wall of the tunnel portion or may be regions of an air-permeable material, such as a perforated, net, mesh or breathable fabric. If desired, the regions 7 may be in the form of chimneys, that is, raised above the surface of the tunnel portion 1 to increase the flow of air through the tunnel.

As indicated in FIG. 9, the material of the tunnel portion 1 and of the funnel portion 3 may alternatively or additionally be supported on hoop-like tubular members 9 which are made of an air-impermeable flexible material which are sealed and provided with non-return valves to allow gas to be compressed within the tubular members in order to inflate and cause the tubular members 9 to become rigid and to form a skeleton which supports the remainder of the tunnel or funnel portion. The valves also allow the tubular members 9 to be deflated. The tubular members may be made, for example, of a plastics or a plastics-coated composite material. The tubular members 9 may be inflated with a bicycle or car tyre pump, a compressed gas canister (containing compressed carbon dioxide, for example), or the like. The device can therefore be readily assembled for use and dismantled for convenient storage. Clothing 11 can hang freely in the upper region of the tunnel portion 1. Ideally the clothing should be oriented to extend in the longitudinal direction of the tunnel portion to facilitate the flow of air through the device.

FIG. 9 also shows a mat 13 or the like which can be used to form a floor for the device. The mat may be an integral part of the device or the tunnel portion of the device or may be separate and may cover all or part of the floor area within the device or the tunnel portion. The mat 13 may be made, for example, of a durable, non-slip material. If separate, the mat 13 may be secured to and separated from the tunnel portion 1 by, for example, a sliding fastener such as a zip fastener, press studs, hook and loop material such as that sold under the trade mark Velcro, and the like.

FIG. 9 additionally shows a transverse clothing support 15 which extends between opposite side walls of the tunnel portion 1, for example between two pneumatic tubes 9, and is provided with apertures 17 for receiving clothes hangers or the like. In this way, the clothes extend in the longitudinal direction of the tunnel portion 1 and facilitate the passage of air through the device. Several such supports 15 may be provided across the tunnel portion 1 depending on the length of the tunnel portion. The clothing support may conveniently be made of a fabric material which has no significant bulk and facilitates storage of the device. Alternatively, the clothing support 15 may be made of a relatively rigid (plastics) material which is hingedly connected to the pneumatic tubes 9 or opposite side walls of the tunnel portion 1.

FIG. 10 shows an alternative clothing support which comprises a partial hoop 21 of fabric or like material, ideally flexible, having a plurality of spacers 23 extending across the hoop inwardly from the external surface of the device. The partial hoop 21 and the spacers are attached to a hanging system 25 for clothes and which comprises a plurality of curved supports 27 which are hinged to each other at their ends and are provided with apertures 29 for receiving clothes hangers or the like. Thus, the clothes extend in the longitudinal direction of the tunnel portion 1. The hoop 21 and supports 27 give rise to turbulence and eddy currents in the air passing through the tunnel portion 1 which serves to dry the clothes hung in the tunnel portion more effectively. The hinged supports 27 contribute both stability and flexibility to the clothing support.

As an alternative to securing the device to a convenient object, the device may be self-supporting and may be maintained in position by means of a weight. One way in which this may be accomplished is shown in FIG. 11. FIG. 11 shows a device with a self-supporting mounting system which comprises upper and lower elongate supports 31, 33. The supports 31 and 33 extend along the inner surface of the tunnel portion 1 and may be secured thereto by any suitable means. The upper supports are mounted on an upright support post 35 which is mounted in a weight 37. The lower surface of the weight 37 is rounded (or part spherical) and is received in a complementary recess provided in a member 39 inserted in the ground. The components are all separable from each other and the supports 31 and 33 and the support post 35 may each be retractable or collapsible. The weight may be, for example, a hollow member which can be filled with water or the like at times when the device is in use. Alternatively, the weight may be made of concrete or the like. The rounded shape of the bottom of the weight 37 allows the device to be moved relative to the ground surface, for example it may be rotated to make best advantage of the current wind direction. A magnetic device may be provided between the weight 37 and the recess 39 to facilitate movement at any time, for example in response to a change in wind direction. Clearly, not all these features are required and, for example, the support post may be mounted in the ground, either fixed or able to rotate.

Although not shown, floats may be provided along the lower external regions of the tunnel portion 1 to allow the device to float in the event of flooding.

1. A device for drying clothes characterised by a tunnel portion, a funnel portion provided at one end of the tunnel portion, and a hanging system for clothes provided within the tunnel portion.

2. A device as claimed in claim 1, characterised in that a funnel portion is provided at each end of the tunnel portion.

3. A device as claimed in claim 1, characterised in that the funnel portion is removably attached to the tunnel portion.

4. A device as claimed in claim 1, characterised in that a skirt is provided at one end of the tunnel portion, the skirt extending around at least a part of the internal periphery of the tunnel portion and extending radially inwardly therefrom.

5. A device as claimed in claim 4, characterised in that the material of the skirt is gathered in the radially inner region thereof and ties are provided to restrict movement of the skirt longitudinally outwardly of the tunnel portion.

6. A device as claimed in claim 1, characterised in that a plurality of tunnel portions are removably connected to each other.

7. A device as claimed in claim 1, characterised in that sides of the tunnel portion extend downwardly substantially to ground level.

8. A device as claimed in claim 1, characterised in that the tunnel portion includes a plurality of supporting structures selected from hoop-like supporting structures or inflatable supporting structures.

9. A device as claimed in claim 1, characterised in that the tunnel portion tapers as it approaches the tunnel portion.

10. A device as claimed in claim 1, characterised in that at least one end of the tunnel portion is provided with a retractable canopy.

11. A device as claimed in claim 10, characterised in that the canopy is provided with at least one aperture.

12. A device as claimed in claim 1, characterised in that one or more vents is provided along the length of the tunnel portion.

13. A device as claimed in claim 1, characterised in that flooring means covers at least a part of the floor of the device.

14. A device as claimed in claim 1, characterised in that the hanging system comprises a clothing support which extends between opposite walls of the tunnel portion.

15. A device as claimed in claim 14, characterised in that the clothing support is hingedly connected to the opposite walls of the tunnel portion.

16. A device as claimed in claim 1, characterised in that clothing support comprises a plurality of supports which are hinged together and are spaced from the surface of the tunnel portion.

17. A device as claimed in claim 16, characterised in that the supports are spaced from the surface of the tunnel portion by fabric material.

18. A device as claimed in claim 1, characterised in that the device is secured relative to the ground by means of a weight attached to the remainder of the device.

19. A device as claimed in claim 18, characterised in that the weight is secured to the remainder of the device by means of elongate supports which extend longitudinally within at least the tunnel portion.

20. A device as claimed in claim 18, characterised in that a lower surface of the weight is rounded and is received in a complementary recess provided in a support member inserted in the ground.

21. (canceled)

22. (canceled)

23. (canceled)

24. (canceled)

25. (canceled)

26. (canceled)

27. (canceled)
